(19) United States
(12) Patent Application Publication
(10) Pub. No.: US 2017/0091821 A1
(43) Pub. Date: Mar. 30, 2017

(54) DISPLAYING AND DETERMINING CUSTOMER DATA

(71) Applicant: SKEDGO PTY LTD, The Rocks (AU)

(72) Inventor: Phil Bookallil, The Rocks (AU)

(73) Assignee: SKEDGO PTY LTD, The Rocks (AU)

(21) Appl. No.: 15/125,424

(22) PCT Filed: Mar. 11, 2015
(86) PCT No.: PCT/AU2015/050097

§ 371 Date: Sep. 12, 2016

(30) Foreign Application Priority Data
Mar. 12, 2014 (AU) 2014900839

(51) Int. Cl. G06Q 30/02; G06Q 10/10

(52) U.S. Cl. CPC G06Q 30/0264; G06Q 10/1095; G06Q 30/0261

(57) ABSTRACT

This disclosure relates to displaying and determining customer data relating to multiple customers. A merchant's device sends a request for customer data. The request comprises request data indicative of a query time and of a query distance. The device then receives customer data indicative of a number of customers that are located within the query distance from a merchant location at the query time based on itineraries defmed by schedule items of the multiple customers. Each of the schedule items is associated with location information and timing information. Finally, the device generates a display to display the customer data. The number of customers that are located within a query distance is according to schedule items, such as calendar entries, of the customers. As a result, the number of customers is predicted accurately based on the calendar entries and represents different travel routes between locations defmed in the schedule items.

### CROSS-REFERENCE TO RELATED APPLICATIONS

The present application claims priority from Australian Provisional Patent Application No 2014900839 filed on 12 Mar. 2014, the content of which is incorporated herein by reference.

### TECHNICAL FIELD

This disclosure relates to displaying and determining customer data.

### BACKGROUND ART

Merchants can advertise their goods and services over a number of channels, including electronic advertising using email, SMS or other data services. However, it is difficult for merchants to advertise only to relevant potential customers instead of advertising indiscriminately to all potential customers in the merchant's database.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF INVENTION

A computer implemented method for displaying customer data relating to multiple customers comprises:
sending a request for customer data, the request comprising request data indicative of a query time and of a query distance;
receiving customer data indicative of a number of customers that are located within the query distance from a merchant location at the query time based on itineraries defined by schedule items of the multiple customers, each of the schedule items being associated with location information and timing information; and
generating a display to display the customer data.

It is an advantage that the number of customers that are located within a query distance is according to schedule items, such as calendar entries, of the customers. As a result, the number of customers can be predicted accurately based on the calendar entries and can represent different travel routes between locations defined in the schedule items.

The display may comprise a number representing the customer data and the number is located in relation to a time range such that the time range represents the query time.

The time range may define a first axis and the symbol may be located in relation to a second axis, such that the second axis indicates the query distance.

The display may comprise a map with an indication of a boundary that indicates locations that are within the query distance from the merchant location.

The display may comprise an input form to allow interaction with the display to create an offer associated with an offer time and an offer distance.

The method may further comprise sending the offer to a server such that the offer is presented to customers that are predicted to be located within the offer distance from the merchant at the offer time.

The display may comprise an offer icon associated with an offer having an offer time and the offer icon may be located in relation to a time range such that the time range represents the offer time.

The time range may define a first axis and the offer icon may be located in relation to a second axis, such that the second axis indicates the offer distance.

The display may comprise a control element associated with the user data and the method may further comprise upon activation of the control element creating a profiling display of customer profiling information.

The profiling display may comprise a graphical representation of the number of customers that are located within a profiling distance from a merchant location over the profiling distance.

The display may comprise a movable graphical element to allow setting the query distance, the method may further comprise performing the steps of receiving the customer data and generating the display in response to the query distance being set.

The display may comprise an indication of a mode of transport that is used by the customers within the query distance from a merchant location at the query time.

The display may be to display the customer data separately for each of multiple modes of transport.

The method may further comprise storing the customer data on a data store.

Software when installed on a computer causes the computer to perform the above method for displaying customer data relating to multiple customers.

A computer system for displaying customer data relating to multiple customers comprises:
a data port
   to send a request for customer data, the request comprising request data indicative of a query time and of a query distance and
   to receive customer data indicative of a number of customers that are located within the query distance from a merchant location at the query time based on itineraries defined by schedule items of the multiple customers, each of the schedule items being associated with location information and timing information; and
a processor to generate a display to display the customer data.

A method for determining customer data relating to multiple customers comprises:
receiving for each of the multiple customers one or more schedule items, each schedule item being associated with location information and timing information;
determining a travel itinerary for each of the multiple customers based on the schedule items;
receiving a request for customer data, the request comprising a query time and a query distance;
determining based on the travel itinerary for each of the multiple customers customer data indicative of a number of customers that are located within the query distance from a merchant at the query time; and
sending the customer data.

Software when installed on a computer causes the computer to perform the method for determining customer data relating to multiple customers.

A computer system for determining customer data relating to multiple customers, comprises:
a data port
   to receive for each of the multiple customers one or more schedule items, each schedule item being associated with location information and timing information and
   to receive a request for customer data, the request comprising a query time and a query distance;
a processor
   to determine a travel itinerary for each of the multiple customers based on the schedule items,
   to determine based on the travel itinerary for each of the multiple customers customer data indicative of a number of customers that are located within the query distance from a merchant at the query time and
to send the customer data using the data port.

Optional features described of any aspect of method, software or computer system, where appropriate, similarly apply to the other aspects also described here.

### BRIEF DESCRIPTION OF DRAWINGS

An example will be described with reference to

FIG. 1 illustrates a computer system for displaying customer data.

FIG. 2 illustrates a method for displaying customer data.

FIG. 3 illustrates a user interface for providing request data.

FIG. 4 illustrates an example scenario.

FIG. 5 illustrates a user interface displaying customer data.

FIG. 6 shows a user interface for entering an offer.

FIG. 7 illustrates a profiling user interface.

FIG. 8 illustrates a computer system for determining customer data.

FIG. 9 illustrates a method for determining customer data.

### BEST MODE FOR CARRYING OUT THE INVENTION

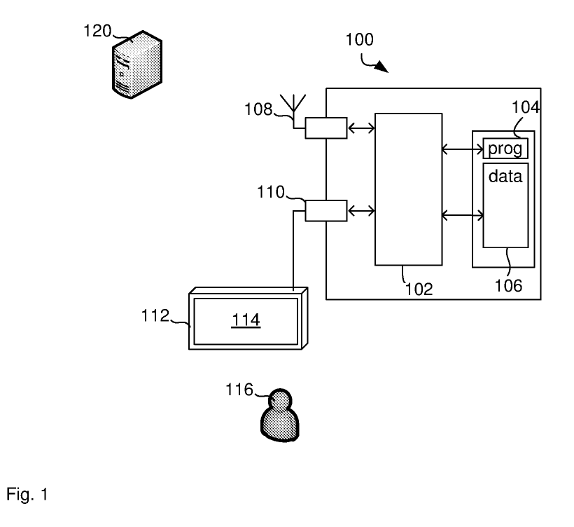

FIG. 1 illustrates a computer system 100 for displaying customer data relating to multiple customers. It is noted here that customers are not only persons that have already purchased goods or services but also include potential customers or more generally, persons of potential interest to the merchant.

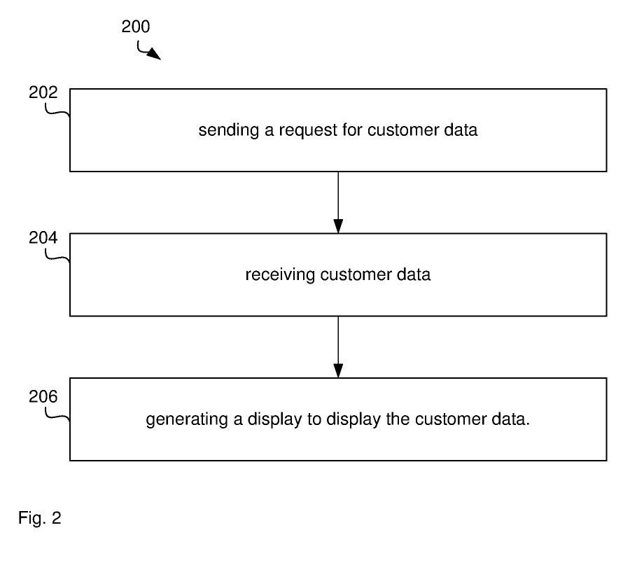

The computer system 100 comprises a processor 102 connected to a program memory 104, a data memory 106, a communication port 108 and a user port 110. The program memory 104 is a non-transitory computer readable medium, such as a hard drive, a solid state disk or CD-ROM. Software, that is an executable program, stored on program memory 104 causes the processor 102 to perform the method in FIG. 2, that is, the processor 102 sends a request for customer data, receives the customer data and generates a display to display the customer data on a screen 112.

The processor 102 may receive data, such as customer data, from data memory 106 as well as from the communications port 108 and the user port 110, which is connected to a screen 112 that shows a visual representation 114 of the customer data to a merchant 116. In one example, the processor 102 sends a request for customer data to a server 120 and receives customer data from server 120 via communications port 108, such as by using a Wi-Fi network according to IEEE 802.11, 3G, the Internet or any combination thereof. The Wi-Fi network may be a decentralised ad-hoc network, such that no dedicated management infrastructure, such as a router, is required or a centralised network with a router or access point managing the network.

Although communications port 108 and user port 110 are shown as distinct entities, it is to be understood that any kind of data port may be used to receive data, such as a network connection, a memory interface, a pin of the chip package of processor 102, or logical ports, such as IP sockets or parameters of functions stored on program memory 104 and executed by processor 102. These parameters may be stored on data memory 106 and may be handled by-value or by-reference, that is, as a pointer, in the source code.

The processor 102 may receive data through all these interfaces, which includes memory access of volatile memory, such as cache or RAM, or non-volatile memory, such as an optical disk drive, hard disk drive, storage server or cloud storage.

It is to be understood that any receiving step may be preceded by the processor 102 determining or computing the data that is later received. For example, the processor 102 determines customer data and stores the customer data in data memory 106, such as RAM or a processor register. The processor 102 then requests the data from the data memory 106, such as by providing a read signal together with a memory address. The data memory 106 provides the data as a voltage signal on a physical bit line and the processor 102 receives the customer via a memory interface.

FIG. 2 illustrates a method 200 as performed by processor 102 for displaying customer data relating to multiple customers. The merchant 116 prepares a request for customer data by inputting a query time and a query distance into touch screen 112.

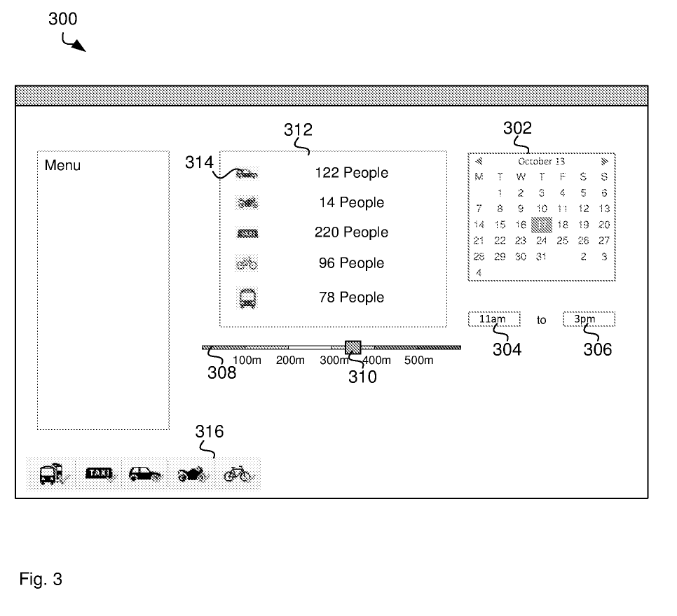

FIG. 3 illustrates a user interface 300 for providing request data. The user interface 300 comprises a selectable calendar 302, where the merchant 116 can select a day by tapping the desired date in the calendar 302. The user interface 300 also comprises a start time input field 304 and an end time input field 306 for providing the start time of the request and the end time of the request respectively. The date, the start time and the end time together are referred to as query time. The query time may be a particular point in time or period of time. In the example of FIG. 3, merchant 116 has provided 11 am to 3 pm on 13 Oct. 2013 as the query time.

User interface 300 further comprises a distance scale 308 and a movable element, such as slider 310. Merchant 116 can move the slider from left to right to adjust a query distance. Of course, the scale 308 and slider 310 may be replaced by other input means, such as a text box or multiple buttons.

Referring back to FIG. 2, once the merchant 116 has provided the query time and the query distance, processor 102 receives the query time and the query distance and sends 202 a request for customer data to server 120. The request comprises request data indicative of the query time and of the query distance, which means that the request data may be exactly the query time and the query distance or may be values derived from the query time and query distance, such as rounded values or indexed values.

In this example, the processor 102 monitors the merchant 116 entering the query time and the query distance and sends the request for customer data every time the merchant 116 enters different data. For example, while merchant 116 slides the slider 310 in FIG. 3, the processor 102 sends a request each time the slider is moved by the equivalent of at least 10 metres.

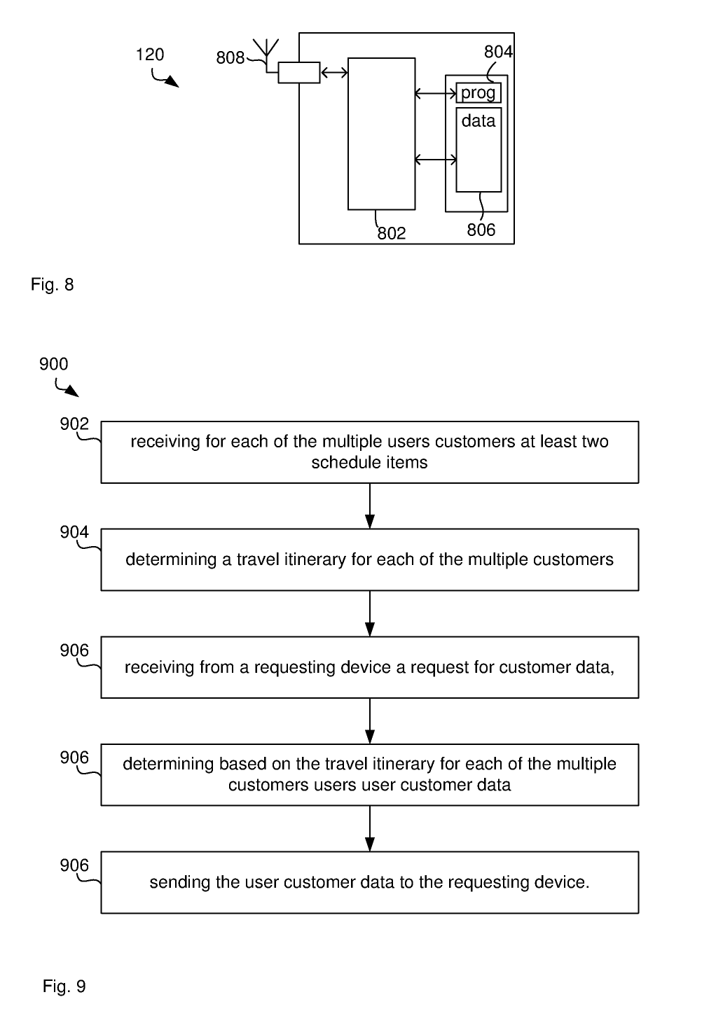

The server 120 determines the customer data as will be explained with reference to FIGS. 8 and 9 and sends the customer data back to the computer system 100.

Again referring back to FIG. 2, processor 102 receives 204 the customer data from the server 120. The customer data is indicative of a number of customers that are located within the query distance from a merchant location at the query time, which is meant to be understood including during a query period. In other words, the processor 102 receives the number of customers that will be within the query distance from the merchant 116 at a given time or time period.

The customers use a calendar application that stores schedule items on server 120 and each of the schedule items is associated with location information and timing information. The number of customers is based on itineraries defined by schedule items of the multiple customers.

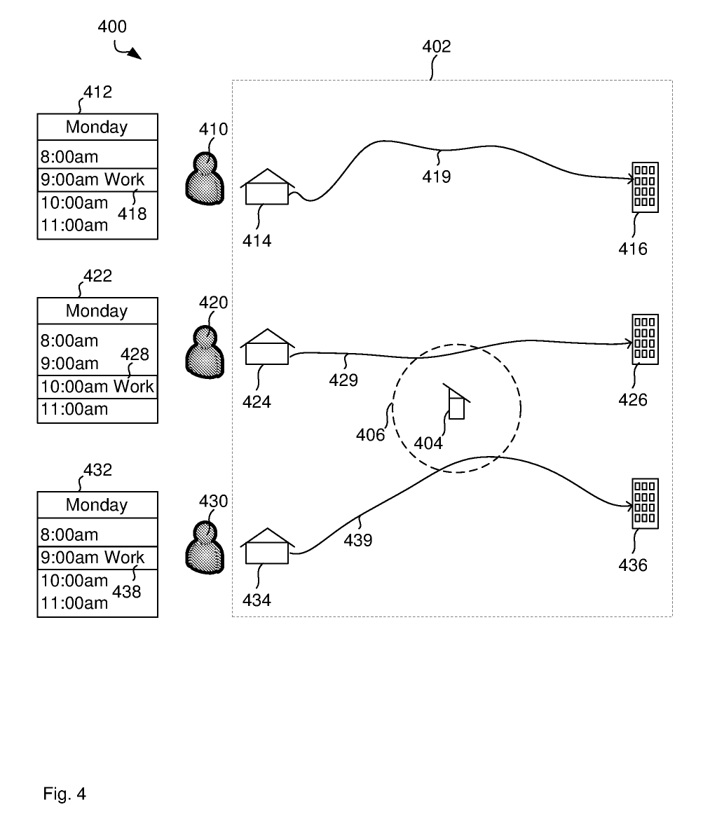

FIG. 4 illustrates an example scenario 400 comprising a schematic map 402 that includes a merchant location 404 and a query distance 406 from the merchant location illustrated as a circle with the merchant location as the centre. In this example, the distance is a direct distance but in other examples the distance may be a distance along a travel path, such as a road. In the latter example, the distance is not a circle but an irregular shape.

Example scenario further comprises three customers 410, 420 and 430 and respective schedules 412, 422 and 432. The map 402 shows the customers' respective home locations 414, 424 and 434 and the customers' respective work locations 416, 426 and 436.

The schedule 412 of first customer 410, such as an Outlook calendar or a Google calendar, comprises schedule item 418. Schedule item 418 indicates that customer 410 will travel from home location 414 to work location 416 on Monday at 9:00 am. In other words, schedule item 418 is associated with location information ‘work’ and time information ‘9:00 am’ and defines an itinerary 419 from the customer's 410 home location 414 to the customer's 410 work location 416. This schedule item 412 is stored on server 120 in FIG. 1 together with location information about the customer's 410 home location 414. This information allows the server 120 to determine the itinerary 419 from the home location 414 to the work location 416. As can be seen in FIG. 4, location information may refer to an exact location, such as GPS coordinates, or may be a label, such as ‘work’ or ‘home’, that is associated with an exact location.

The itinerary 419 may be a route to drive from home location 414 to work location 416 or a connection using public transport or airplanes at certain times.

In the example of FIG. 4 it is assumed that the query time is the period from 9:30 am to 10:00 am. It can be seen that the itinerary 419 of first customer 410 does not come within the query distance 406 and therefore, first customer 410 would not be included into the number of customers that is provided to the device 100.

In contrast, second customer 420 has a schedule item 428 indicating that the second customer 420 will arrive at work at 10:00am. Map 402 shows a second itinerary 429 for the second customer 420 travelling to work location 436. It can be seen that second itinerary 429 does come within the query distance 406 during the query time and therefore, second customer 420 is included into the number of customers that are located within the query distance 406 from the merchant 404 at the query time.

Third customer 430 has a third schedule item 438 indicating that third customer 430 will arrive at work location 436 at 9:00 am. Since this time is before the query time period from 9:30 am to 10:00 am, third customer 430 is not included into the number of customers although a third itinerary 439 comes within the query distance 406.

As a result, in the scenario 400 the number of customers is one.

Referring back to FIG. 2, after receiving the customer data in step 204 processor 102 stores the customer data on a data store, such as RAM, and generates 206 a display to display the customer data.

One example has already been explained with reference to FIG. 3. In that example, a text box 312 comprises an indication, such as car symbol 314, of the mode of transport that the customers use within the query distance from a merchant location at the query time. Text box 312 shows the number of customers separately for each of multiple modes of transport. For example, 122 customers will drive by car within 350 m from the merchant location at 17 Oct. 2013 between 11 am and 3 pm.

User interface 300 further comprises a control element 316 where the merchant 116 can select which modes of transport should be included into the number of customers. For example, the merchant 116 may consider that customers travelling nearby in public transport are unlikely to exit the public transport for an impulse purchase, such as a coffee, while customers travelling by car are more likely to do so. Therefore, merchant 116 may decide to exclude customers travelling on public transport from the customer data.

As explained above, user interface 300 may operate in real-time such that while the merchant slides the slider 310, the processor 102 continuously sends requests for customer data. The processor 102 the also receives the customer data and generates the display in response to the query distance being set by the slider 310.

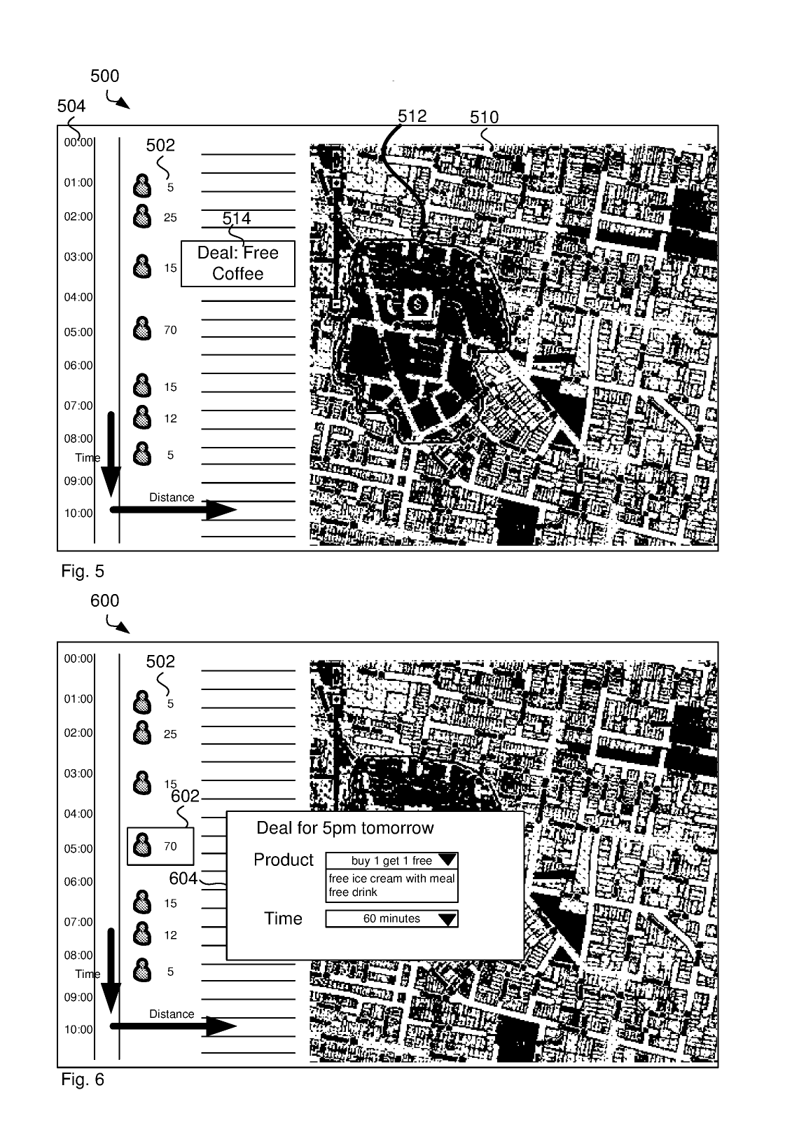

FIG. 5 illustrates another example of a user interface 500 generated by processor 102. Multiple numbers, such as number 502, represent the received customer data. Number 502 is located in relation to a time range 504 such that the time range represents the query time. For example, number 502 indicates that five customers will be travelling within the query distance between 1:00 pm and 2:00 pm. The number 502 may further be displaced along the horizontal axis that represents the query distance. For example, multiple numbers may be displayed horizontally aligned for the same time period while each number represents a different query distance. This way, merchant 116 can see at what query distance the number of customers drops significantly.

User interface 500 further comprises a map 510 that includes an indication of a boundary 512. This indicates locations that are within the query distance from the merchant location. The indication of a boundary may be the boundary itself, such as in the form of a solid thick line, or may be a shaded area that fills the boundary. FIG. 5 shows that the boundary 512 is not a circle since the processor 102 considers the actual travel distance along the roads when creating the boundary 512.

FIG. 6 shows another user interface 600 for entering an offer. In this example, merchant 116 selects number 602 to present an offer to 70 customers travelling nearby around 5:00 pm, such as fifteen minutes before and after, for a previously set query distance. Once the merchant 116 selects number 602 processor 102 generates an input form 604. The input form 604 allows the merchant 116 to interact with the display to create an offer.

The input form 604 comprises an offer type form 606 and an offer duration form 608. In this example, merchant 116 selects ‘buy one get one free’ as the offer type but other types are possible, such as a reduced price or a superior product for the same price as an inferior product.

As the merchant 116 has already selected the offer time, such as 5:00 pm and a query distance, these values are used to create an offer associated with the offer time and the query distance as the offer distance. In other words, the processor 102 generates a display to display the number of customers that will be within the query distance at the query time and the created offer is created to be presented to exactly those customers.

Processor 102 receives the data provided in input form 604 and sends the input data to server 120 such that the offer is presented to the customers that are predicted to be located within the offer distance from the merchant at the offer time. For example, the server 120 generates additional schedule items for the offer in the schedules of the selected users, such that these users are alerted of the offer at the relevant time.

Referring back to FIG. 5, an offer icon 514 associated with a created offer is generated. The offer icon 514 is located in relation to time range 504 such that the time range 504 represents the offer time. For example, offer 510 lasts from 3:00 pm to 4:00 pm. The location of the offer icon, such as represented by the dimension, along the horizontal axis may represent the offer distance, such that the merchant 116 can easily see which offers are valid for particular offer distances.

When the merchant 116 selects a control element, such as a button (not shown) or one of the numbers of customers, such as by tapping number 502, processor 102 generates a profiling user interface.

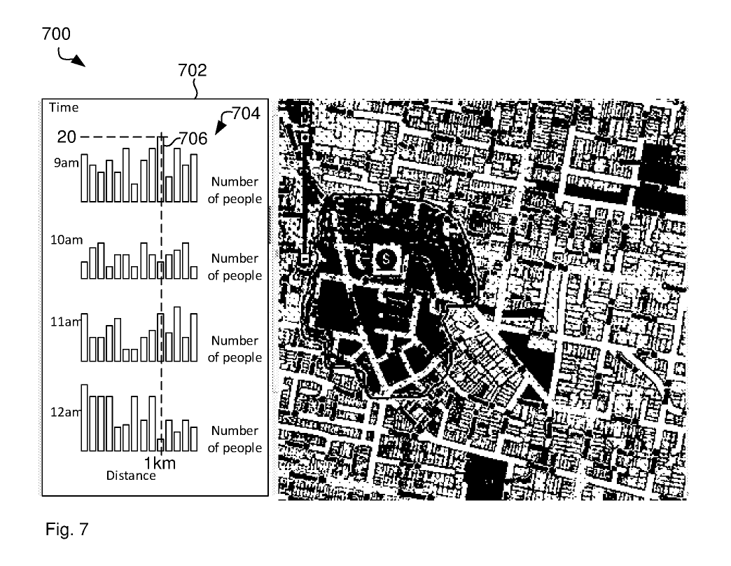

FIG. 7 illustrates a profiling user interface 700 comprising a chart pane 702. The chart pane 702 comprises a bar chart for each time period, such as bar chart 704 for the time period of 30 minutes before and after 9 am. In this example, bar chart 704 comprises one bar for a distance of 100 metres. Example bar 706 shows to the merchant 116 that between 8:30 am and 9:30 am there will be 20 customers within a distance between 900 m and 1 km from the merchant 116. The merchant 116 can then tap bar 706 on touch screen 112 to start creating an offer for these 20 customers or for these 20 customers and all other customers that are closer than 1 km at that time, which includes all bars to the left of the 1 km distance value (cumulative value).

FIG. 8 illustrates server 120 of FIG. 1 in more detail. Server 120 is a computer system for determining customer data relating to multiple customers. Similar to computer system 100 in FIG. 1, server 120 comprises a processor 802 connected to a program memory 804, a data memory 806 and a communication port 808 to connect to the Internet. The program memory 804 is a non-transitory computer readable medium, such as a hard drive, a solid state disk or CD-ROM. Software, that is an executable program, stored on program memory 804 causes the processor 802 to perform the method in FIG. 9, that is, the processor 802 receives schedule items determines travel itineraries, receives a request for customer data, determines customer data and sends the customer data to the requesting device 100 in FIG. 1.

FIG. 9 illustrates a method 900 as performed by processor 802 for determining customer data relating to multiple customers. Processor 802 receives 902 for each of the multiple customers one or more schedule items, such as by accessing the schedule items on data store 806. As explained with reference to FIG. 4, each schedule item is associated with location information and timing information. Based on the location information and timing information schedule items processor 802 determines 904 a travel itinerary for each of the multiple customers. The processor 802 may perform an optimisation procedure for selecting the shortest or quickest route out of multiple options with different modes of transport. In one example, processor 802 queries public transport time schedules to incorporate public transport options into the optimisations.

Once merchant 116 prepares a request for customer data and processor 102 sends the request to server 120, processor 802 of server 120 receives from the requesting device 100 the request for customer data. The request comprises a query time and a query distance. As explained above with reference to FIG. 4, processor 802 determines based on the travel itinerary for each of the multiple customers customer data. The customer data is indicative of a number of customers that are located within the query distance from a merchant at the query time. Finally, processor 802 sends the customer data to the requesting device 100.

Although computer 100 and server 120 are explained as separate devices, it is to be understood that the functionalities of these devices may equally be integrated into a single device. For example, a single webserver may host a calendar application that receives schedule items from a database to determine customer data. That webserver may send the customer to an internal datastore, such as RAM, and subsequently receive the customer data from the RAM. The webserver can then generate a graphically enriched website that looks like the user interfaces of FIGS. 3, 5, 6 and 7 to display the customer data. Merchant 116 then uses a browser to access that website and to view the generated display of customer data.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A computer implemented method for displaying customer data relating to multiple customers, the method comprising:
sending a request for customer data, the request comprising request data indicative of a query time and of a query distance;
receiving customer data indicative of a number of customers that are located within the query distance from a merchant location at the query time based on itineraries defined by schedule items of the multiple customers, each of the schedule items being associated with location information and timing information; and
generating a display to display the customer data.

2. The method of claim 1, wherein the display comprises a number representing the customer data and the number is located in relation to a time range such that the time range represents the query time.

3. The method of claim 2, wherein the time range defines a first axis and the symbol is located in relation to a second axis, such that the second axis indicates the query distance.

4. The method of claim 1, wherein the display comprises a map with an indication of a boundary that indicates locations that are within the query distance from the merchant location.

5. The method of claim 1, wherein the display comprises an input form to allow interaction with the display to create an offer associated with an offer time and an offer distance.

6. The method of claim 5, further comprising sending the offer to a server such that the offer is presented to customers that are predicted to be located within the offer distance from the merchant at the offer time.

7. The method of claim 1, wherein the display comprises an offer icon associated with an offer having an offer time and the offer icon is located in relation to a time range such that the time range represents the offer time.

8. The method of claim 7, wherein the time range defines a first axis and the offer icon is located in relation to a second axis, such that the second axis indicates the offer distance.

9. The method of claim 1, wherein the display comprises a control element associated with the user data and the method further comprises upon activation of the control element creating a profiling display of customer profiling information.

10. The method of claim 9, wherein the profiling display comprises a graphical representation of the number of customers that are located within a profiling distance from a merchant location over the profiling distance.

11. The method of claim 1, wherein the display comprises a movable graphical element to allow setting the query distance, the method further comprising performing the steps of receiving the customer data and generating the display in response to the query distance being set.

12. The method of claim 1, wherein the display comprises an indication of a mode of transport that is used by the customers within the query distance from a merchant location at the query time.

13. The method of claim 12, wherein the display is to display the customer data separately for each of multiple modes of transport.

14. The method of claim 1, further comprising storing the customer data on a data store.

15. A non-transitory computer readable medium with an executable program stored thereon that when executed causes a computer to perform the method of claim 1.

16. A computer system for displaying customer data relating to multiple customers, the computer system comprising:
a data port to:
send a request for customer data, the request comprising request data indicative of a query time and of a query distance, and
receive customer data indicative of a number of customers that are located within the query distance from a merchant location at the query time based on itineraries defined by schedule items of the multiple customers, each of the schedule items being associated with location information and timing information; and
a processor to generate a display to display the customer data.

17. A method for determining customer data relating to multiple customers, the method comprising:
receiving for each of the multiple customers one or more schedule items, each schedule item being associated with location information and timing information;
determining a travel itinerary for each of the multiple customers based on the schedule items;
receiving a request for customer data, the request comprising a query time and a query distance;
determining based on the travel itinerary for each of the multiple customers customer data indicative of a number of customers that are located within the query distance from a merchant at the query time; and
sending the customer data.

18. A non-transitory computer readable medium with an executable program stored thereon that when executed causes a computer to perform the method of claim 17.

19. A computer system for determining customer data relating to multiple customers, the computer system comprising:
a data port to:
receive for each of the multiple customers one or more schedule items, each schedule item being associated with location information and timing information, and
receive a request for customer data, the request comprising a query time and a query distance; and
a processor to:
determine a travel itinerary for each of the multiple customers based on the schedule items,
determine based on the travel itinerary for each of the multiple customers customer data indicative of a number of customers that are located within the query distance from a merchant at the query time, and
send the customer data using the data port.
